(19) United States
(12) Patent Application Publication
(10) Pub. No.: US 2013/0126334 A1
(43) Pub. Date: May 23, 2013

(54) METHOD FOR PRODUCING GLASS SUBSTRATE FOR MAGNETIC DISKS, AND METHOD FOR PRODUCING MAGNETIC DISK

(71) Applicants: Yoshihiro Tawara, Shinjuku-ku (JP); Kiyoshi Hayakawa, Shinjuku-ku (JP); Taiji Osada, Shinjuku-ku (JP)

(72) Inventors: Yoshihiro Tawara, Shinjuku-ku (JP); Kiyoshi Hayakawa, Shinjuku-ku (JP); Taiji Osada, Shinjuku-ku (JP)

(21) Appl. No.: 13/807,085

(22) PCT Filed: Aug. 31, 2011
(86) PCT No.: PCT/JP2011/069784

§ 371 Date: Dec. 27, 2012

(30) Foreign Application Priority Data
Aug. 31, 2010 (JP) 2010-195099

(51) Int. Cl. G11B 5/84

(52) U.S. Cl. CPC G11B 5/8404
USPC 204/192.15; 451/41

(57) ABSTRACT

The present invention provides a method for manufacturing a glass substrate for a magnetic disk that enables grinding processing with fixed abrasive grains without a decrease of the grinding rate and that can manufacture a high quality glass substrate at low cost. The present invention is a method for manufacturing a glass substrate for a magnetic disk, including a grinding step of grinding a main surface of a glass substrate using a lubricant and a surface plate that has a grinding surface provided with fixed abrasive grains containing diamond particles. In the grinding step, for example, by adding Al₂O₃, Al³⁺ is allowed to be contained in the lubricant that is supplied to the surface on which grinding processing is performed of the glass substrate. The lubricant has an Al³⁺ content preferably in a range of 0.05 g/L to 1.0 g/L.

### TECHNICAL FIELD

The present invention relates to a method for manufacturing a magnetic disk glass substrate to be provided in a magnetic disk device such as a hard disk drive (HDD) and to a method for manufacturing a magnetic disk.

### BACKGROUND ART

A magnetic disk is one of the information recording media provided in magnetic disk drives such as hard disk drives (HDDs). The magnetic disk is configured with a thin him such as a magnetic layer formed on a substrate, and conventionally an aluminum substrate has been used as the substrate. However, recently, in response to the pursuit of high recording density, glass substrates with which the space between the magnetic head and the magnetic disk can be narrower than that attained with aluminum substrates have been increasingly used. The glass substrate surface is highly precisely polished to achieve a high recording density such that the flying height of the magnetic head can be as small as possible in recent years, the demand for HDDs with a larger storage capacity at lower cost has been increasing, and in order to meet this, further quality improvement and cost reduction of glass substrates for magnetic disks are also required.

As stated above, it is essential for a magnetic disk to have a highly smooth surface to achieve a low flying height that is necessary for a high recording density. In order to attain a highly smooth magnetic disk surface, after all, a highly smooth substrate surface is required, and it is thus necessary to highly precisely polish the surface of a glass substrate.

In order to prepare such a glass substrate, a grinding method with fixed abrasive grains that uses a diamond sheet in a lapping step where loose abrasive grains have been used conventionally is proposed (for example, Patent Document 1). The diamond sheet refers to pellets in which diamond abrasive grains are fixed using a support such as resin (for example, acrylic resin) (or a sheet to which such pellets are attached). With conventional loose abrasive grains, abrasive grains with uneven shapes are present non-uniformly between the surface plate and the glass, and thus the load on the grains is not uniform. If the load concentrates, glass cracks deeply because the elasticity of the surface of the cast-iron surface plate is poor. Accordingly, the processed surface of glass is rough, and large amounts of glass need to be removed in the subsequent mirror-polishing step, thus making it difficult to reduce processing costs. On the other hand, in grinding with fixed abrasive grains using a diamond sheet, abrasive grains are uniformly present on the sheet surface, and thus the load does not concentrate. In addition, abrasive grains are fixed to the sheet using a resin, and therefore even when the load is applied to the abrasive grains, cracks in the processed surface is shallow because of the highly elastic nature of the resin that fixes the abrasive grains. Thus, the roughness of the processed surface can be reduced, the burden on the subsequent steps is reduced, and the processing costs can be reduced.

After this grinding (lapping) step, mirror-polishing processing is performed to obtain a highly precise flat surface.

Meanwhile, current HDDs can achieve a recording density as high as about 400 gigabits per square inch, and for example, it is possible to store about 250 gigabytes of information on a 2.5-inch (65-mm-diameter) magnetic disk. As a means for achieving even a higher recording density such as 500 gigabytes and 1 terabyte, thermally assisted magnetic recording, for example, has been proposed. Magnetic disks applied to this thermally assisted magnetic recording are required to have a higher heat resistance than the heat resistance that is currently required. Accordingly, it is suitable to use a highly heat resistant glass material also for a substrate.

### CITATION LIST

### Patent Literature

[PLT 1] JP-A-2001-191247

### SUMMARY OF INVENTION

### Technical Problem

As stated above, according to the grinding method using a diamond sheet with fixed abrasive grains, the roughness of the processed surface can be reduced, the burden on the subsequent mirror-polishing step is reduced, and the processing costs of glass substrates can be reduced. However, the research conducted by the inventors revealed the following problems.

That is, with a grinding method that uses fixed abrasive grains, it was observed that the grinding rate decreased as the processing time progressed. FIG. 1 shows the change of the grinding rate observed as the processing time progressed. In the case where ordinary glass (aluminosilicate glass that is commonly used for conventional glass substrates for magnetic disks) is used, the grinding rate decreases as the processing time progresses, and in particular, in the case where heat resistant glass (Tg of approximately 600° C. or greater) is used, the grinding rate decreases significantly. It is thus not possible to simultaneously improve the surface qualify and reduce the processing costs.

The present invention has been conceived in order to solve the foregoing conventional problems, and an object of the present invention is to provide a method for manufacturing a glass substrate for a magnetic disk that enables grinding processing with fixed abrasive grains without a decrease of the grinding rate and that can manufacture a high quality glass substrate at low cost, and a method for manufacturing a magnetic disk that uses a glass substrate obtained by said method.

### Solution to Problem

As a result of having also investigated the reason why, as stated above, the grinding rate decreases as the processing time progresses in the case of a grinding method that uses fixed abrasive grains, the inventors inferred as follows.

In the case of conventional grinding processing that uses loose abrasive grains, the abrasive grains move freely thus repetitively rotate even when grinding dust that is generated as grinding processing progresses adheres to the abrasive grains, and are discharged by friction between the surface plate and glass without grinding dust building up on the abrasive grain surface. On the other hand, in grinding processing that uses fixed abrasive grains, because abrasive grains are fixed, abrasive grains do not rotate when grinding dust adheres thereto, and grinding dust builds up and solidifies on the abrasive grain surface, thus resulting in the blocking of fixed abrasive grains by grinding dust and decrease of the grinding rate by inhibition of processing. In this case, it is difficult to wash away (remove), by the action of a lubricant (also called a coolant) supplied to the surface on which processing is performed, the grinding dust that has built up on the abrasive grain surface. Another reason is that grinding processing with fixed abrasive grains yields a smaller grinding amount and enables more precise processing than grinding processing that uses loose abrasive grains, and therefore particles of grinding dust discharged as processing progresses mostly have a small diameter and easily adhere to the abrasive grain surface.

Also, the inventors inferred the reason why the processing rate significantly decreases especially with heat resistant glass as follows.

Silica and alumina, which are main components of glass, have structures in which silicon atoms are bonded via oxygen and aluminum atoms are bonded via oxygen, and it is possible to control physical properties such as heat resistance by changing the proportions of silica and alumina. For example, hi-silica that contains a large amount of silicon (the amount of aluminum is relatively small) has a uniform crystal structure, thus being stable against, for example, heat, i.e., being heat resistant. According to the inventors' research, grinding dust discharged as processing progresses from such heat resistant glass having a small aluminum content is likely to aggregate in an environment such as grinding processing where the contact part between grindstone and the glass substrate surface can be locally exposed to a high-temperature and high-pressure environment, and facilitates build-up and solidification of grinding dust on the abrasive grain surface. Accordingly, heat resistant glass that has a smaller aluminum content than ordinary glass or that does not contain aluminum is usually likely to generate blocking of fixed abrasive grains by grinding dust, resulting in a substantial decrease of the grinding rate by inhibition of processing. In other words, it seems that the grinding rate is substantially decreased in grinding processing performed on glass because the alumina content in the glass is small.

Thus, as a result of having focused on a lubricant on which research was not conducted previously and carried out extensive research to solve the foregoing problems, the inventors found that adding Al₂O₃ or the like to a lubricant to allow Al³⁺ to be contained therein can inhibit build-up and solidification of grinding dust, prevents blocking of fixed abrasive grains caused by grinding dust that inhibits grinding processing per formed with fixed abrasive grains, and can improve the decrease of the grinding rate. The inventors also found that the effect is significantly demonstrated particularly in grinding processing performed on heat resistant glass. That is, the inventors also found that the effect is significantly demonstrated in grinding processing performed on glass that has a small alumina content.

In other words, the present invention has the following aspects.

### (Aspect 1)

A method for manufacturing a glass substrate for a magnetic disk, including a grinding step of grinding a main surface of a glass substrate using a lubricant and a surface plate that has a grinding surface provided with a fixed abrasive grain containing diamond particles, Al³⁺ being contained in the lubricant that is supplied to the surface on which grinding processing is performed of the glass substrate.

### (Aspect 2)

The method for manufacturing a glass substrate for a magnetic disk according to aspect 1, wherein Al₂O₃ is added to the lubricant.

### (Aspect 3)

The method for manufacturing a glass substrate for a magnetic disk according to aspect 1 or 2, wherein the lubricant has an Al³⁺ content in a range of 0.05 g/L to 1.0 g/L.

### (Aspect 4)

The method for manufacturing a glass substrate for a magnetic disk according to any of aspects 1 to 3, wherein the glass substrate contains:

SiO₂ in an amount of 50 to 75 mol %,

Al₂O₃ in an amount of 0 to 5 mol %,

BaO in an amount of 0 to 2 mol %,

Li₂O in an amount of 0 to 3 mol %,

ZnO in an amount of 0 to 5 mol %,

Na₂O and K₂O in a total amount of 3 to 15 mol %,

MgO, CaO, SrO, and BaO in a total amount of 14 to 35 mol %, and

ZrO₂, TiO₂, La₂O₃, Y₂O₃, Yb₂O₃, Ta₂O₅, Nb₂O₅, and HfO₂ in a total amount of 2 to 9 mol %, and

has a molar ratio [(MgO+CaO)/(MgO+CaO+SrO+BaO)] in a range of 0.85 to 1 and a molar ratio [Al₂O₃/(MgO+CaO)] in a range of 0 to 0.30.

### (Aspect 5)

A method for manufacturing a magnetic disk, including forming at least a magnetic layer on a magnetic disk glass substrate obtained by the manufacturing method of any of aspects 1 to 4.

### (Aspect 6)

A method for manufacturing a glass substrate for a magnetic disk, including a grinding step of grinding a main surface of the glass substrate using a lubricant and a surface plate that has a grinding surface provided with a plurality of fixed abrasive grains, an additive to facilitate discharge of an aggregate of sludge accumulated on the grinding surface due to grinding being contained in the lubricant that is supplied to the surface on which grinding processing is performed of the glass substrate.

### (Aspect 7)

The method for manufacturing a glass substrate for a magnetic disk according to aspect 6, wherein the glass substrate is composed of glass containing SiO₂ as a main component and Al₂O₃ in an amount of 0 to 15 wt %.

### (Aspect 8)

The method for manufacturing a glass substrate for a magnetic disk according to aspect 6 or 7, wherein the lubricant is composed of an aqueous solution containing one or more selected from the group consisting of amine, mineral oil, kerosene, mineral spirit, water soluble oil emulsion, polyethylene imine, ethylene glycol, monoethanolamine, diethanolamine, triethanolamine, propylene glycol, amine borate, boric acid, amine carboxylate, pine oil, indole, thioamine salt, amide, hexahydro-1,3,5-triethyltriazine, carboxylic acid, sodium 2-mercaptobenzothiazole, isopropanolamine, triethylenediamine tetraacetate, propylene glycol methyl ether, benzotriazol, sodium 2-pyridinethiol-1-oxide, and hexylene glycol.

### (Aspect 9)

The method for manufacturing a glass substrate for a magnetic disk according to any of aspects 6 to 8, wherein the additive added to the lubricant is selected from Al₂O₃, aluminum ammonium sulfate, aluminum bromide, aluminum chloride, aluminum hydroxide, aluminum iodide, aluminum nitrate, aluminum phosphate, aluminum potassium sulfate, and aluminum sulfate.

### (Aspect 10)

The method for manufacturing a glass substrate for a magnetic disk according to any of aspects 6 to 9, wherein a content of the additive added to the lubricant is in a range of 0.05 g/L to 1.0 g/L.

### Advantageous Effects of Invention

According to the present invention, it is possible to improve the decrease of the grinding rate in conventional grinding processing that uses fixed abrasive grains. That is, it is possible to perform grinding processing with fixed abrasive grains without a decrease of the grinding rate and manufacture a high quality glass substrate at low cost. The effect is significant particularly in grinding processing on heat; resistant glass (in other words, glass whose alumina content is small). Also, use of the resulting glass substrate makes it possible to obtain a highly reliable magnetic disk.

### BRIEF DESCRIPTION OF DRAWINGS

FIG. 1 is a diagram showing the change of the grinding rate in relation to the processing time in a conventional grinding step performed on a glass substrate using fixed abrasive grains.

FIG. 2 is a diagram showing the change of the grinding rate in relation to the number of processing batches in Example 1-1 and a comparative example (conventional).

FIG. 3 is a diagram showing the change of the grinding rate in relation to the number of processing batches in Example 2-1 and a comparative example (conventional).

### DESCRIPTION OF EMBODIMENTS

Embodiments of the present invention will now be described in detail below.

The present invention is, as described in aspect 1 above, a method for manufacturing a glass substrate for a magnetic disk, including a grinding step of grinding a main surface of the glass substrate using a lubricant and a surface plate that has a grinding surface provided with fixed abrasive grains containing diamond particles, Al³⁺ being contained in the lubricant that is supplied to the surface on which grinding processing is performed of the glass substrate.

A magnetic disk glass substrate is usually manufactured through a rough grinding step (rough lapping step), a shaping step, a precision grinding step (precision lapping step), an end face polishing step, a main surface polishing step, and a chemical strengthening step.

In the manufacture of this magnetic disk glass substrate, first, molten glass is molded into a disk-shaped glass substrate (glass disk) by direct pressing. Other than using such direct pressing, a glass substrate (glass disk) may also be obtained by cutting plate glass that has been produced by a downdraw method or a float method into a glass substrate with a predetermined size. Then, this molded glass substrate (glass disk) is ground (lapped) to improve the dimensional accuracy and shape accuracy in this grinding step, a double-side lapping machine is used, and the main surfaces of the glass substrate are ground using hard abrasive grains such as those of diamond. By grinding the main surfaces of the glass substrate in this manner, the substrate is processed so as to have a predetermined thickness and flatness and attain a predetermined surface roughness.

The present invention relates to an improvement of this grinding step. The grinding step in the present invention is a grinding step that uses fixed abrasive grains containing diamond particles, and for example, in a double-side lapping machine, a glass substrate that is held by a carrier is tightly placed between the upper and lower surface plates to which pellets in which hard abrasive grains such as diamond abrasive grains are fixed using a support such as resin (for example, acrylic resin) (or a sheet to which such pellets are attached (referred to as a diamond sheet or the like)) are attached, then the glass substrate is moved relative to the upper and lower surface plates while the glass substrate is pressed by the upper and lower surface plates at a predetermined pressure, and thus both main surfaces of the glass substrate are ground simultaneously. At this time, a lubricant (coolant) is supplied in order to cool the processed surfaces and facilitate processing. This lubricant after being used is supplied back to the lapping machine and used cyclically

In the present invention, the grinding step is performed using such an Al³⁺-containing lubricant. In order to allow Al³⁺ be contained in a lubricant, for example, a method that adds a substance, such as Al₂O₃, that contains Al and becomes ionized in an aqueous solution is convenient. The substance to be added may be solid or liquid, and it is convenient that the substance is dissolved in water or the like in advance and added in the form of an Al³⁺-containing fluid. Other examples of the substance that contains Al and becomes ionized in an aqueous solution include aluminum ammonium sulfate, aluminum bromide, aluminum chloride, aluminum hydroxide, aluminum iodide, aluminum nitrate, aluminum phosphate, aluminum potassium sulfate, aluminum sulfate, and the like.

Normally Al₂O₃ is poorly soluble in water, but under a high-load condition as in grinding processing, a high-temperature and high-pressure environment is locally created, and thus Al₂O₃ partially leaches and supplies Al ions. Also, in the case where Al₂O₃ is added to the lubricant, use of Al₂O₃ having a small particle diameter of 1 μm or less makes it possible to prevent scratches on the main surfaces of a glass substrate.

In this way, allowing Al³⁺ to be contained in the lubricant makes it possible to suppress build-up and solidification of grinding dust that is created as grinding processing progresses, and prevent blocking caused by grinding dust that inhibits grinding processing performed with fixed abrasive grains. Accordingly, the decrease of the grinding rate that is the problem of conventional grinding processing that uses fixed abrasive grains can be improved in particular, in grinding processing performed on heat resistant glass in which the content of Al₂O₃ among the glass ingredients subjected to melting is small, the effect of improving the decrease of the grinding rate attained by allowing Al³⁺ to be contained in the lubricant is significantly demonstrated.

The lubricant used in the present invention is not particularly limited, and a water-soluble lubricant that has a large cooling effect and is highly safe at a production site is particularly suitable. For example, an aqueous solution is suitable that contains one or more of amine, mineral oil, kerosene, mineral spirit, water soluble oil emulsion, polyethylene imine, ethylene glycol, monoethanolamine, diethanolamine, triethanolamine, propylene glycol, amine borate, boric acid, amine carboxylate, pine oil, indole, thioamine salt, amide, hexahydro-1,3,5-triethyltriazine, carboxylic acid, sodium 2-mercaptobenzothiazole, isopropanolamine, triethylenediamine tetraacetate, propylene glycol methyl ether, benzotriazol, sodium 2-pyridinethiol-1-oxide, and hexylene glycol. The temperature of the lubricant when used (fluid temperature) is also not particularly limited, and a temperature around 40° C. is usually suitable.

In the present invention, it is preferable that in the lubricant the content of the substance that contains Al and becomes ionized in an aqueous solution, i.e., the content of the substance that can supply Al³⁺ ions, is in the range of 0.05 g/L, to 1.0 g/L.

When the content of the substance that can supply Al³⁺ ions in the lubricant is less than 0.05 g/L, the effect of improving the decrease of the grinding rate that is the problem of conventional grinding processing that uses fixed abrasive grains is not sufficiently attained. In particular, the grinding rate decreases considerably in grinding processing on heat resistant glass, and it is thus not possible to improve this grinding rate decrease. On the other hand, even when the content of the substance that can supply Al³⁺ ions in the lubricant exceeds 1.0 g/L, the effect of improving the grinding rate decrease does not change.

in the present invention, it is preferable that glass (the type of glass) constituting the glass substrate is amorphous aluminosilicate glass. Mirror-polishing the surface of such a glass substrate can yield a smooth mirror-finished surface, and the post-processing strength is favorable. A preferable example of such aluminosilicate glass is glass that contains SiO₂ as a main component and Al₂O₃ in an amount no greater than 20 wt %. Furthermore, glass that contains SiO₂ as a main component and Al₂O₃ in an amount no greater than 15 wt % is more preferable. Specifically, it is possible to use phosphorus oxide-free amorphous aluminosilicate glass that contains as main components SiO₂ in an amount of 62 wt % to 75 wt %, Al₂O₃ in an amount of 5 wt % to 1.5 wt %, Li₂O in an amount of 4 wt % to 10 wt %, Na₂O in an amount of 4 wt % to 1.2 wt %, and ZrO₂ in an amount of 5.5 wt % to 15 wt %, and has an Na₂O/ZrO₂ weight ratio of 0.5 to 2.0 and an Al₂O₃/ZrO₂ weight ratio of 0.4 to 2.5. It is desirable that glass does not contain an alkali earth metal oxide such as CaO or MgO. An example of such glass may be N5 Glass (trade name) manufactured by HOYA Corporation.

As the aforementioned heat resistant glass, glass that contains SiO₂ in an amount of 50 to 75 mol %, Al₂O₃ in an amount of 0 to 5 mol %, BaO in an amount of 0 to 2 mol %, Li₂O in an amount of 0 to 3 mol %, ZnO in an amount of 0 to 5 mol %, Na₂O and K₂O in a total amount of 3 to 15 mol %, MgO, CaO, SrO, and BaO in a total amount of 14 to 35 mol %, and ZrO₂, TiO₂, La₂O₃, Y₂O₃, Yb₂O₃, Ta₂O₅, Nb₂O₅, and HfO₂ in a total amount of 2 to 9 mol %, and has a molar ratio [(MgO+CaO)/(MgO+CaO+SrO+BaO)] in the range of 0.85 to 1 and a molar ratio [Al₂O₃/(MgO+CaO)] in the range of 0 to 0.30 can be preferably used.

Also, glass may contain SiO₂ in an amount of 56 to 75 mol %, Al₂O₃ in an amount of 1 to 9 mol %, alkali metal oxide(s) selected from the group consisting of Li₂O, Na₂O, and K₂O in a total amount of 6 to 15 mol %, alkaline earth metal(s) selected from the group consisting of MgO, CaO, and SrO in a total amount of 10 to 30 mol %, and oxide(s) selected from the group consisting of ZrO₂, TiO₂, Y₂O₃), La₂O₃, Gd₂O₃, Nb₂O₅, and Ta₂O₅ in a total amount of greater than 0 and no greater than 1.0 mol %.

In the present invention, the Al₂O₃ content in the glass composition is preferably 15 wt % or less, and more preferably the Al₂O₃ content is 5 mol % or less.

The grinding step is usually performed, as stated above, through two stages, i.e., a rough grinding step (first grinding step) and a precision grinding step (second grinding step), and in this case, it is desirable to apply a grinding step that uses fixed abrasive grains containing diamond particles and a lubricant in accordance with the present invention at least to the latter-stage precision grinding step. With regard to the former-stage rough grinding step, a conventional grinding step that uses surface plates composed of, for example, cast iron may be performed depending on the glass disk molding method, and also a grinding step that uses fixed abrasive grains containing diamond particles and a lubricant in accordance with the present invention may be applied to the former-stage rough grinding step. The fixed abrasive grains are not limited to diamond particles, abrasive grains made of other materials may be used.

After this grinding step, mirror polishing processing is performed to obtain a highly precise flat surface in the present invention, the grinding step uses a grinding method performed with fixed abrasive grains in accordance with the present invention as opposed to a conventional grinding method performed with loose abrasive grains, thus making it possible to reduce the roughness of the processed surface. Accordingly the amount of glass removed in the subsequent mirror-polishing processing step is small, the processing load is reduced, and the processing costs can be reduced.

It is suitable to perform a mirror-polishing method on the glass substrate using a polishing pad with a polyurethane or like polisher while supplying a slurry (polishing liquid) containing an abrasive that is made of a metal oxide such as cerium oxide or colloidal silica. A highly smooth glass substrate can be obtained by, for example, polishing the glass substrate using a cerium oxide-based abrasive (first polishing processing) and final-polishing (mirror-polishing) the glass substrate using colloidal silica abrasive grains (second polishing processing).

In the present invention, the surface of a glass substrate after the aforementioned grinding processing and mirror-polishing processing is preferably a mirror surface having an arithmetic average roughness Ra of 0.2 nm or less. Ra and Rmax in the present invention both denote roughness that is calculated in accordance with the Japanese Industrial Standards (JIS) B 0601.

From a practical viewpoint, the surface roughness (for example, maximum roughness Rmax, arithmetic average roughness Ra) in the present invention is preferably the surface roughness of a surface shape obtained by a measurement under an atomic force microscope (AFM).

In the present invention, it is preferable to perform chemical strengthening treatment after the first polishing processing and before the polishing processing. As a method for the chemical strengthening treatment, it is preferable to use, for example, a low-temperature ion-exchange method that performs ion exchange in a temperature range not exceeding the glass transition point, for example, at a temperature of 300° C. or greater and 400° C. or less. The chemical strengthening treatment is a treatment in which a glass substrate is brought into contact with a molten chemical strengthening salt so that an alkali metal element having a relatively large atomic radius in the chemical strengthening salt and an alkali metal element having a relatively small atomic radius in the glass substrate are ion-exchanged, thus the alkali metal element having a relatively large atomic radius permeates through the surface layer of the glass substrate, and compressive stress is generated on the surface of the glass substrate. The tempered glass substrate has excellent impact resistance, and it is thus particularly suitable to provide the tempered glass substrate in, for example, an HDD for mobile use. As a chemical strengthening salt, an alkali metal nitrate such as potassium nitrate or sodium nitrate can be preferably used.

The present invention also provides a method for manufacturing a magnetic disk using the above-described magnetic disk glass substrate. In the present invention, the magnetic disk is manufactured by forming at least a magnetic layer on the magnetic disk glass substrate of the present invention. As a material of the magnetic layer, hexagonal-system CoCrPt-based or CoPt-based ferromagnetic alloy with a large anisotropic magnetic field can be used. The magnetic layer is preferably formed on the glass substrate by a sputtering method, for example, a DC magnetron sputtering method. Interposing an underlayer between the glass substrate and the magnetic layer makes it possible to control the orientation direction and size of magnetic particles in the magnetic layer. For example, use of a cubic-system underlayer such as Cr-based alloy makes it possible to orient, for example, the direction of easy magnetization of the magnetic layer along the magnetic disk surface. In this case, the magnetic disk of a longitudinal magnetic recording type is manufactured. Also, for example, use of a hexagonal-system underlayer containing Ru and Ti makes is possible to orient, for example, the direction of easy magnetization of the magnetic layer along the normal of the plane of the magnetic disk. In this case, the magnetic disk of a perpendicular magnetic recording type is manufactured. The underlayer can be formed in the same manner as the magnetic layer by a sputtering method.

It is preferable to form a protective layer and a lubricating layer in this order on the magnetic layer. An amorphous hydrogenated carbon-based protective layer is suitable as the protective layer. The protective layer can be formed by for example, a plasma CVD method. As the lubricating layer, a lubricant that has a functional group at the terminal of the main chain of a perfluoropolyether compound can be used. In particular, it is preferable that the lubricant contains as a main component a perfluoropolyether compound that has a hydroxyl group as a polar functional group at the terminal. The lubricating layer can be coated and formed by a dipping method.

Use of the glass substrate obtained according to the present invention makes it possible to obtain a highly reliable magnetic disk.

### EXAMPLES

Below, embodiments of the present invention shall be described in detail by way of examples. Note that the present invention is not limited to the following examples.

### Example 1-1

A magnetic disk glass substrate of this example was manufactured through (1) rough lapping step (rough grinding step), (2) shaping step, (3) precision lapping step (precision grinding step), (4) end face polishing step, (5) main surface polishing step (first polishing step), (6) chemical strengthening step, and (7) main surface polishing step (second polishing step) as described below.

(1) Rough Lapping Step

First, a disk-shaped glass substrate made of aluminosilicate glass and having a diameter of 66 mm and a thickness of 1.0 mm was obtained from molten glass by direct pressing using upper, lower, and drum molds. Other than using such direct pressing, a glass substrate may also be obtained by cutting plate glass that has been produced by a downdraw method or a float method into a glass substrate with a predetermined size. As this aluminosilicate glass, glass for chemical strengthening containing SiO₂ in an amount of 62 to 75 wt %, ZrO₂ in an amount of 5.5 to 15 wt %, Al₂O₃ in an amount of 5 to 15 wt %, Li₂O in an amount of 4 to 1.0 wt %, and Na₂O in an amount of 4 to 1.2 wt % was used.

Then, a lapping step was performed on this glass substrate to improve the dimensional accuracy and shape accuracy. This lapping stop was performed using a double-side lapping machine and abrasive particles with a #400 particle size. Specifically, the glass substrate that was held by a carrier was tightly placed between the upper and lower surface plates, the load was set at about 100 kg, the sun gear and the internal gear of the lapping machine were rotated, and thus both main surfaces of the glass substrate accommodated in the carrier were lapped so as to have a surface accuracy of 0 to 1 μm and a surface roughness (Rmax) of about 6 μm.

(2) Shaping Step

Next, a cylindrical grindstone was used to create a hole in the center of the glass substrate, the outer circumferential end face was ground so as to obtain a diameter of 65 mm, and then predetermined chamfering processing was performed on the outer circumferential end face and the inner circumferential end face. The surface roughness of the end faces of the glass substrate at this time was about 4 μm in Rmax. Generally, a magnetic disk with an outer diameter of 65 mm is used in a 2.5-inch HDD (hard disk drive).

(3) Precision Lapping Stop

Using a double-side lapping machine, this precision lapping step was performed while the glass substrate that was held by a carrier was tightly placed between the upper and lower surface plates to which pellets containing diamond abrasive particles with a #1000 particle size (abrasive particle diameter of about 2 to 10 μm) fixed with acrylic resin were attached. A lubricant in which Al₂O₃ (particle diameter of about 1 μm) had been added to a coolant (temperature of 40° C.) so as to achieve a 0.06 g/L content was used.

Specifically, the load was set at about 400 kg, the sun gear and the internal gear of the lapping machine were rotated, and thus both main surfaces of the glass substrate accommodated in the carrier were lapped so as to have a surface roughness of about 2 μm in Rmax and about 0.2 μm in Ra.

The glass substrate after the lapping step was immersed in respective cleaning baths of water and a neutral detergent (for ultrasonication) in a sequential manner and thus ultrasonically cleaned.

In this lapping step, one batch included 100 substrates, and processing was performed on 10 batches. FIG. 2 shows the change of the grinding rate that occurred as the batch-wise processing progressed (see the data points represented by ▪ (solid squares) in the figure). As for a comparative example, FIG. 2 also shows the change of the grinding rate that occurred as the batch-wise processing progressed (see the data points represented by □ (blank squares) in the figure) when a precision lapping step was performed in the same manner as in the foregoing example except that no Al₂O₃ was added to the lubricant (coolant). As can be understood from the results provided in FIG. 2, in the case where Al₂O₃ was added to the lubricant (coolant) to allow Al³⁺ to be contained therein as in this example, a downward trend of the grinding rate was barely observed even when the batch-wise processing progressed, and it is thus possible to improve the decrease of the grinding rate that is observed as the batch-wise processing progresses if the processing is performed only with a conventional (comparative example) lubricant.

(4) End Face Polishing Step

Then, the inner and outer circumferential end faces of the glass substrate were brush-polished while the glass substrate was rotated so as to have a roughness of about 0.3 nm in Ra. Then, the surface of the glass substrate after this end face polishing was washed with water.

(5) Main Surface Polishing Step (First Polishing Step)

Then, a first polishing step to remove cracks or distortion remaining after the above-described lapping step was performed using a double-side polishing machine. In the double-side polishing machine, a glass substrate that is held by a carrier is tightly placed between the upper and lower surface plates to which polishing pads have been attached, the carrier is meshed with the sun gear and the internal gear, and the glass substrate is pressed between the upper and lower surface plates. Then, a polishing liquid is supplied between the polishing pads and the surfaces of the glass substrate to be polished, the upper and lower surface plates are rotated, and thus the glass substrate makes an orbital motion while rotating on its axis on the surface plates so that both main surfaces of the glass substrate are polished simultaneously. Specifically, the first polishing step was performed using a hard polisher (hard urethane foam) as a polisher. RO water in which cerium oxide (average particle diameter of 1.3 μm) was dispersed as a polisher was used as a polishing liquid, a load of 100 g/cm² was applied, and the polishing time was 1.5 minutes. The glass substrate that had undergone the first polishing step was immersed in respective cleaning baths of a neutral detergent, pure water, pure water, IPA (isopropyl alcohol), and IPA (vapor drying) in a sequential manner so as to be ultrasonically cleaned and dried.

(6) Chemical Strengthening Step

Then, chemical strengthening was performed on the glass substrate that had undergone the aforementioned cleaning. Chemical strengthening was performed by providing a chemical strengthening solution in which potassium nitrate and sodium nitrate were mixed, heating this chemical strengthening solution to 380° C., and immersing the cleaned and dried glass substrate in the chemical strengthening solution for about 4 hours.

(7) Main Surface Polishing Step (Second Polishing Step)

Then, a second polishing process was performed using the same double-side polishing machine as used in the first polishing step, but polishing pads with a soft polisher (suede) (polyurethane foam with an Asher C hardness of 72) was used. This second polishing step is a mirror-polishing step to finish the main surfaces of the glass substrate into smooth mirror surfaces with a surface roughness of, for example, about 0.2 nm or less in Ra while retaining the flat surfaces obtained in the first polishing step described above. RO water in which colloidal silica (average particle diameter of 0.8 μm) was dispersed was used as a polishing liquid, a load of 1.00 g/cm² was applied, and the polishing time was 5 minutes. The glass substrate having been subjected to the second polishing process was immersed in respective cleaning baths of neutral detergent, pure water, pure water, IPA, and IPA (vapor drying) in a sequential manner so as to be ultrasonically cleaned and dried.]

Also, the surface roughness of the main surfaces of the glass substrate obtained through the foregoing processes was measured using an atomic force microscope (AFM), revealing that the glass substrate with an ultra-smooth surface of 2.13 nm in Rmax and 0.20 nm in Ra was obtained. In addition, the surfaces of the glass substrate were analyzed under an atomic force microscope (AFM) and an electron microscope, thus revealing that the glass substrate had mirror surfaces, and no surface defects such as protrusions or cracks were observed.

The resulting glass substrate had an outer diameter of 65 mm, an inner diameter of 20 mm, and a thickness of 0.635 mm.

In this manner, the magnetic disk glass substrate of this example was obtained.

### Example 1-2

A precision lapping process was performed in the same manner as in Example 1-1 except that the coolant (temperature of 40° C.) that served as a lubricant had an Al₂O₃ content of 1.0 WI, in the precision lapping process as performed in Example 1-1 above. Then, a magnetic disk glass substrate was obtained in the same manner as in Example 1-1 except for the precision lapping step.

Table 1 below shows the change of the grinding rate that occurred as the batch-wise processing progressed in the precision lapping step of this example.

### Example 1-3

A precision lapping process was performed in the same manner as in Example 1-1 except that the coolant (temperature of 40° C.) that served as a lubricant had an Al₂O₃ content of 0.03 g/L in the precision lapping process as performed in Example 1-1 above. Then, a magnetic disk glass substrate was obtained in the same manner as in Example 1-1 except for the precision lapping step.

Table 1 below shows the change of the grinding rate that occurred as the batch-wise processing progressed in the precision lapping step of this example.

### Example 1-4

A precision lapping process was performed in the same manner as in Example 1-1 except that the coolant (temperature of 40° C.) that served as a lubricant had an Al₂O₃ content of 1.5 g/L in the precision lapping process as performed in Example 1-1 above. Then, a magnetic disk glass substrate was obtained in the same manner as in Example 1-1 except for the precision lapping step.

Table 1 below shows the change of the grinding rate that occurred as the batch-wise processing progressed in the precision lapping step of this example.

TABLE 1

| | Grinding rate [μm/min] | | |
|---|---|---|---|
| | 1st batch | 5th batch | 10th batch |
| Example 1-2 | 4.8 | 4.5 | 4.4 |
| Example 1-3 | 4.5 | 4.0 | 3.0 |
| Example 1-4 | 4.8 | 4.5 | 4.5 |

As can be understood from the results presented in Table 1, adding Al₂O₃ to a lubricant can improve the decrease of the grinding rate that occurs as the batch-wise processing progresses if the processing is performed only with a conventional coolant. Meanwhile, in Example 1-3 where the Al₂O₃ content in the lubricant is less than the preferable range, the effect of improving the decrease of the grinding rate that occurs as the batch-wise processing progresses if the processing is performed only with a conventional lubricant is small. Also, as can be understood from Example 1-4 where the Al₂O₃ content in the lubricant exceeds the preferable range, the effect is not different even when Al₂O₃ is added in an amount exceeding a specific level,

Moreover, as Example 1-5, a precision lapping step was performed in the same manner as in Example 1-1 except that aluminum ammonium sulfate was added in an amount of 0.06 g/L to the coolant (temperature of 40° C.) that served as a lubricant in the precision lapping step as performed in Example 1-1 above. Then, a magnetic disk glass substrate was obtained in the same manner as in Example 1-1 except for the precision lapping step. The change of the grinding rate that occurred as the batch-wise processing progressed in the precision lapping step was the same as that in Example 1-1.

### Example 2-1

In this example, as for the type of a glass substrate, heat resistant glass (Tg: no less than 650° C.) containing SiO₂ in an amount of 50 to 75 mol %, Al₂O₃ in an amount of 0 to 5 mol %, BaO in an amount of 0 to 2 mol %, Li₂O in an amount of 0 to 3 mol %, ZnO in an amount of 0 to 5 mol %, Na₂O and K₂O in a total amount of 3 to 15 mol % MgO, CaO, SrO, and BaO in a total amount of 14 to 35 mol %, and ZrO₂, TiO₂, La₂O₃, Y₂O₃, Ta₂O₅, Nb₂O₅, and HfO₂ in a total amount of 2 to 9 mol %, and having a molar ratio [(MgO+CaO)/(MgO+CaO+SrO+BaO)] in a range of 0.85 to 1 and a molar ratio [Al₂O₃/(MgO+CaO)] in a range of 0 to 0.30 was used.

A magnetic disk glass substrate was manufactured by performing the same steps as in Example 1-1 above on a glass substrate composed of this heat resistant glass. Note that a coolant (temperature of 4.0° C.) to which Al₂O₃ had been added in an amount of 0.06 g/L was used as a lubricant; in the precision lapping step.

In this example also, as for the precision lapping step, one batch included 100 substrates, and processing was performed on 10 batches. FIG. 3 shows the change of the grinding rate that occurred as the batch-wise processing progressed (see the data points represented by • (solid circles) in the figure). As for a comparative example, FIG. 3 also shows the change of the grinding rate that occurred as the batch-wise processing progressed (see the data points represented by ∘ (blank circles) in the figure) when a precision lapping step was performed in the same manner as in the foregoing example except that no Al₂O₃ was added to the lubricant (coolant). As can be understood from the results provided in FIG. 3, in the case where Al₂O₃ was added to the lubricant (coolant) to allow Al³⁺ to be contained therein as in this example, a downward trend of the grinding rate was barely observed even when the batch-wise processing progressed, and it is thus possible to significantly improve the substantial decrease of the grinding rate that occurs as the batch-wise processing progresses if the processing is performed on a heat resistant glass substrate only with a conventional (comparative example) lubricant.

### Example 2-2

A precision lapping process was performed in the same manner as in Example 2-1 except that the coolant (temperature of 40° C.) that served as a lubricant had an Al₂O₃ content of 1.0 g/L in the precision lapping process as performed in Example 2-1 above. Then, a magnetic disk glass substrate was obtained in the same manner as in Example 2-1 except for the precision lapping step.

Table 2 below shows the change of the grinding rate that occurred as the batch-wise processing progressed in the precision lapping step of this example.

### Example 2-3)

A precision lapping process was performed in the same manner as in Example 2-1 except that the coolant (temperature of 40° C.) that served as a lubricant had an Al₂O₃ content of 0.03 g/L in the precision lapping process as performed in Example 2-1 above. Then, a magnetic disk glass substrate was obtained in the same manner as in Example 2-1 except for the precision lapping step.

Table 2 below shows the change of the grinding rate that occurred as the batch-wise processing progressed in the precision lapping step of this example.

### Example 2-4

A precision lapping process was performed in the same manner as in Example 2-1 except that the coolant (temperature of 4.0° C. that served as a lubricant had an Al₂O₃ content of 1.5 g/L in the precision lapping process as performed in Example 2-1 above. Then, a magnetic disk glass substrate was obtained in the same manner as in Example 2-1 except for the precision lapping step.

Table 2 below shows the change of the grinding rate that occurred as the batch-wise processing progressed in the precision lapping step of this example.

TABLE 2

| | Grinding rate [μm/min] | | |
|---|---|---|---|
| | 1st batch | 5th batch | 10th batch |
| Example 2-2 | 4.6 | 4.3 | 4.0 |
| Example 2-3 | 4.0 | 3.1 | 3.0 |
| Example 2-4 | 4.7 | 4.3 | 4.1 |

As can be understood from the results presented in Table 2, adding Al₂O₃ to the lubricant can significantly improve the substantial decrease of the grinding rate that occurs as the batch-wise processing progresses if the processing is performed on a heat resistant substrate only with a conventional coolant. Meanwhile, in Example 2-3 where the Al₂O₃ content in the lubricant is less than the preferable range, the effect of improving the decrease of the grinding rate that occurs as the batch-wise processing progresses if the processing is performed only with a conventional lubricant is small. Also, as can be understood from Example 2-4 where the Al₂O₃ content in the lubricant exceeds the preferable range, the effect is not different even when Al₂O₃ is added in an amount exceeding a specific level.

Moreover, as Example 2-5, a precision lapping step was performed in the same manner as in Example 2-1 except that aluminum ammonium sulfate was added in an amount of 0.06 g/L to the coolant (temperature of 40° C.) that served as a lubricant in the precision lapping step as performed in Example 2-1 above. Then, a magnetic disk glass substrate was obtained in the same manner as in Example 2-1 except for the precision lapping step. The change of the grinding rate that occurred as the batch-wise processing progressed in the precision lapping step was the same as that in Example 2-1.

### Example 3

A magnetic disk for perpendicular magnetic recording was manufactured by performing the following film forming step on the magnetic disk glass substrate obtained in Example 1-1 described above.

Specifically, an adhesive layer in the form of a Ti-based alloy thin film, a soft magnetic layer in the form of a CoTaZr alloy thin film, an underlayer in the form of a Ru thin film, a perpendicular magnetic recording layer in the form of a CoCrPt alloy thin film, a carbon protective layer, and a lubricating layer were laminated in a sequential manner on the glass substrate. The protective layer is to prevent degradation of the magnetic recording layer caused by contact with a magnetic head. The protective layer is composed of hydrogenated carbon and yields wear resistance. The lubricating layer was formed by a dipping method using an alcohol-modified perfluoropolyether liquid lubricant.

A specific glide characteristics test was performed on the resulting magnetic disk. There was no particular defect, and favorable results were obtained.

Also, a magnetic disk for perpendicular magnetic recording was manufactured by performing the same film forming step as above on the magnetic disk glass substrate obtained in Example 2-1.

A specific glide characteristics test was performed on the resulting magnetic disk. There was no particular defect, and favorable results were obtained.

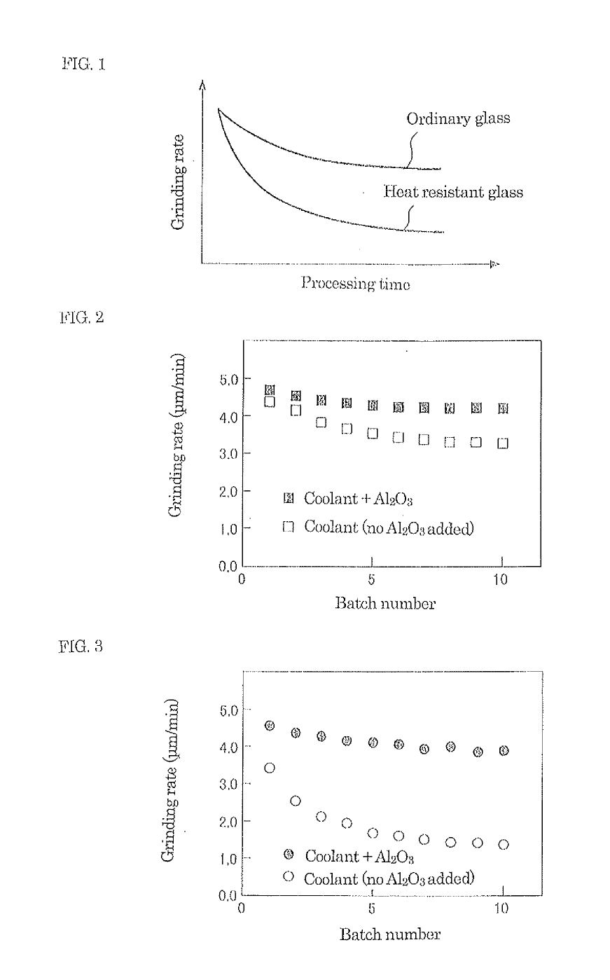

### FIG. 1

Grinding rate
Processing time
Ordinary glass
Heat resistant glass

### FIG. 2

Grinding rate (μm/min)
Batch number

### Coolant +Al₂O₃

Coolant (no Al₂O₃ added)

### FIG. 3

Grinding rate (μm/min)
Batch number

### Coolant +Al₂O₃

Coolant (no Al₂O₃ added)

1. A method for manufacturing a glass substrate for a magnetic disk, comprising grinding a main surface of a glass substrate using a lubricant and a surface plate that has a grinding surface provided with a fixed abrasive grain containing diamond particles,
Al³⁺ being contained in the lubricant that is supplied to the surface on which grinding processing is performed of the glass substrate.

2. The method for manufacturing a glass substrate for a magnetic disk according to claim 1, wherein Al₂O₃ is added to the lubricant.

3. The method for manufacturing a glass substrate for a magnetic disk according to claim 1, wherein the lubricant has an Al³⁺ content in a range of 0.05 g/L to 1.0 g/L.

4. The method for manufacturing a glass substrate for a magnetic disk according to claim 1, wherein the glass substrate contains:
SiO₂ in an amount of 50 to 75 mol %,
Al₂O₃ in an amount of 0 to 5 mol %,
BaO in an amount of 0 to 2 mol %,
Li₂O in an amount of 0 to 3 mol %.
ZnO in an amount of 0 to 5 mol %,
Na₄O and K₂O in a total amount of 3 to 15 mol %,
MgO, CaO, SrO, and BaO in a total amount of 14 to 35 mol %, and
ZrO₂, TiO₂, La₂O₃, Yb₂O₃, Yb₂O₃, Ta₂O₅, Nb₂O₅, and HfO₂ in a total amount of 2 to 9 mol %, and
has a molar ratio [(MgO+CaO)/(MgO+CaO+SrO+BaO)] in a range of 0.85 to 1 and a molar ratio [Al₂O₃/(MgO+CaO)] in a range of 0 to 0.30.

5. A method for manufacturing a magnetic disk, comprising forming at least a magnetic layer on a magnetic disk glass substrate obtained by the manufacturing method of claim 1.

6. A method for manufacturing a glass substrate for a magnetic disk, comprising grinding a main surface of a glass substrate using a lubricant and a surface plate that has a grinding surface provided with a plurality of fixed abrasive grains,
an additive to facilitate discharge of an aggregate of sludge accumulated on the grinding surface due to grinding being contained in the lubricant that is supplied to the surface on which grinding processing is performed of the glass substrate.

7. The method for manufacturing a glass substrate for a magnetic disk according to claim 6, wherein the glass substrate is composed of glass containing SiO₂ as a main component and Al₂O₃ in an amount of 0 to 15 wt %.

8. The method for manufacturing a glass substrate for a magnetic disk according to claim 6, wherein the lubricant is composed of an aqueous solution containing one or more selected from the group consisting of amine, mineral oil, kerosene, mineral spirit, water soluble oil emulsion, polyethylene imine, ethylene glycol, monoethanolamine, diethanolamine, triethanolamine, propylene glycol, amine borate, boric acid, amine carboxylate, pine oil, indole, thioamine salt, amide, hexahydro-1,3,5-triethyltriazine, carboxylic acid, sodium 2-mercaptobenzothiazole, isopropanolamine, triethylenediamine tetraacetate, propylene glycol methyl ether, benzotriazol, sodium 2-pyridinethiol-1-oxide, and hexylene glycol.

9. The method for manufacturing a glass substrate for a magnetic disk according to claim 6, wherein the additive added to the lubricant is selected from Al₂O₃, aluminum ammonium sulfate, aluminum bromide, aluminum chloride, aluminum hydroxide, aluminum iodide, aluminum nitrate, aluminum phosphate, aluminum potassium sulfate, and aluminum sulfate.

10. The method for manufacturing a glass substrate for a magnetic disk according to claim 6, wherein a content of the additive added to the lubricant is in a range of 0.05 g/L to 1.0 g/L.

11. The method for manufacturing a glass substrate for a magnetic disk according to claim 2, wherein the lubricant has an Al³⁺ content in a range of 0.05 g/L to 1.0 g/L.

12. The method for manufacturing a glass substrate for a magnetic disk according to claim 2, wherein the glass substrate contains:
SiO₂ in an amount of 50 to 75 mol %,
Al₂O₃ in an amount of 0 to 5 mol %,
BaO in an amount of 0 to 2 mol %,
Li₂O in an amount of 0 to 3 mol %,
ZnO in an amount of 0 to 5 mol %,
Na₂O and K₂O in a total amount of 3 to 15 mol %,
MgO, CaO, SrO, and BaO in a total amount of 14 to 35 mol %, and
ZrO₂, TiO₂, La₂O₃, Y₂O₃, Yb₂O₃, Ta₂O₅, Nb₂O₅, and HfO₂ in a total amount of 2 to 9 mol %, and
has a molar ratio [(MgO+CaO)/(MgO+CaO+SrO+BaO)] in a range of 0.85 to 1 and a molar ratio [Al₂O₃/(MgO+CaO)] in a range of 0 to 0.30.

13. The method for manufacturing a glass substrate for a magnetic disk according to claim 3, wherein the glass substrate contains:
SiO₂ in an amount of 50 to 75 mol %,
Al₂O₃ in an amount of 0 to 5 mol %,
BaO in an amount of 0 to 2 mol %,
Li₂O in an amount of 0 to 3 mol %,
ZnO in an amount of 0 to 5 mol %.
Na₂O and K₂O in a total amount of 3 to 15 mol %.
MgO, CaO, SrO, and BaO in a total amount of 14 to 35 mol %, and
ZrO₂, TiO₂, La₂O₃, Y₂O₃, Yb₂O₃, Nb₂O₅, and HfO₂ in a total amount of 2 to 9 mol %, and
has a molar ratio [(MgO+CaO)/(MgO+CaO+SrO+BaO)] in a range of 0.85 to 1 and a molar ratio [Al₂O₃/(MgO+CaO)] in a range of 0 to 0.30.

14. A method for manufacturing a magnetic disk, comprising forming at least a magnetic layer on a magnetic disk glass substrate obtained by the manufacturing method of claim 2.

15. A method for manufacturing a magnetic disk, comprising forming at least a magnetic layer on a magnetic disk glass substrate obtained by the manufacturing method of claim 3.

16. A method for manufacturing a magnetic disk, comprising forming at least a magnetic layer on a magnetic disk glass substrate obtained by the manufacturing method of claim 4.

17. The method for manufacturing a glass substrate for a magnetic disk according to claim 7, wherein the lubricant is composed of an aqueous solution containing one or more selected from the group consisting of amine, mineral oil, kerosene, mineral spirit, water soluble oil emulsion, polyethylene imine, ethylene glycol, monoethanolamine, diethanolamine, triethanolamine, propylene glycol, amine borate, boric acid, amine carboxylate, pine oil, indole, thioaminc salt, amide, hexahydro-1,3,5-triethyltriazine, carboxylic acid, sodium 2-mercaptobenzothiazole, isopropanolamine, triethylenediamine tetraacetate, propylene glycol methyl ether, benzotriazol, sodium 2-pyridinethiol-1-Oxide, and hexylene glycol.

18. The method for manufacturing a glass substrate for a magnetic disk according to claim 7, wherein the additive added to the lubricant is selected from Al₂O₃, aluminum ammonium sulfate, aluminum bromide, aluminum chloride, aluminum hydroxide, aluminum iodide, aluminum nitrate, aluminum phosphate, aluminum potassium sulfate, and aluminum sulfate.

19. The method for manufacturing a Mass substrate for a magnetic disk according to claim 8, wherein the additive added to the lubricant is selected from Al₂O₃, aluminum ammonium sulfate, aluminum bromide, aluminum chloride, aluminum hydroxide, aluminum iodide, aluminum nitrate, aluminum phosphate, aluminum potassium sulfate, and aluminum sulfate.

20. The method for manufacturing a glass substrate for a magnetic disk according to claim 7, wherein a content of the additive added to the lubricant is in a range of 0.05 g/L to 1.0 g/L.
